(19) United States
(12) Patent Application Publication
(10) Pub. No.: US 2015/0248548 A1
(43) Pub. Date: Sep. 3, 2015

(54) INCREASING ACCESS SECURITY WITH TIME SINCE LAST ACCESS

(71) Applicant: International Business Machines Corporation, Armonk, NY (US)

(72) Inventors: Shareef F. Alshinnawi, Durham, NC (US); Gary D. Cudak, Creedmoor, NC (US); Jeffrey S. Holland, Durham, NC (US); Robert B. Rainey, Morrisville, NC (US)

(73) Assignee: International Business Machines Corporation, Armonk, NY (US)

(21) Appl. No.: 14/192,953

(22) Filed: Feb. 28, 2014

(51) Int. Cl. G06F 21/44; G06F 21/31

(52) U.S. Cl. CPC G06F 21/44; G06F 21/31

(57) ABSTRACT

A computer program product for controlling access to a resource of an electronic device includes program instructions for executing a method. The method stores a first password and a second password in memory of the electronic device, wherein the first password and the second password are used to allow a user to gain access to a resource of the electronic device, and wherein the second password has greater password strength than the first password. The method further includes, during a first time period passing since the user last accessed the resource, granting the user access to the resource in response to receiving the first password, and, during a second time period following the first time period, granting the user access to the resource only in response to receiving the second password. An alternative method increases the number of required security measures as a function of time since the last access.

### BACKGROUND

1. Field of the Invention

The present invention relates to security and authentication of a user attempting to gain access to a resource of an electronic device, such as a mobile communications device.

2. Background of the Related Art

Mobile communication devices, such as telephones, are an integral part of everyday life in a modern society. Telephones that are connected to a land line are even on the decline, as people become accustomed to having a mobile phone with them at all times. The functions and features available on a mobile phone continue to expand, including apps, a web browser, a camera, full physical or virtual keypads, touchscreens, wifi and Bluetooth connectivity, texting and email, and more.

Furthermore, a mobile communication device may store private information, such as pictures, passwords, payment information and other information that a user may not want shared. Security measures may be implemented on the mobile communication device in order to prevent others from gaining access to the private information or otherwise using the features of the device without authorization. Such security measures may include biometric input, such as facial recognition or finger print recognition. However, a more common security measure will require successful entry of a previously stored password.

Depending upon the level of security desired, the user may adopt a password that has a commensurate degree of strength. A weak password may have fewer and more common characters and a strong password will have more characters selected from a variety of character types. For example, some security systems will require a minimum of eight characters, include at least one capital letter, one number and one special character. Still further, a security system may disallow common character strings that are found in a dictionary, such as “Password”.

### BRIEF SUMMARY

One embodiment of the present invention provides a computer program product for controlling access to a resource of an electronic device, the computer program product comprising a computer readable storage medium having program instructions embodied therewith, wherein the program instructions are executable by a processor to cause the processor to perform a method. The method comprises storing a first password and a second password in memory of the electronic device, wherein the first password and the second password are used to allow a user to gain access to a resource of the electronic device, and wherein the second password has greater password strength than the first password. The method further comprises, during a first time period passing since the user last accessed the resource, granting the user access to the resource in response to receiving the first password, and, during a second time period following the first time period, granting the user access to the resource only in response to receiving the second password.

Another embodiment of the present invention provides a computer program product for controlling access to a resource of an electronic device, the computer program product comprising a computer readable storage medium having program instructions embodied therewith, wherein the program instructions are executable by a processor to cause the processor to perform a method. The method comprises establishing multiple security measures that must be satisfied before a user can gain access to a resource of an electronic device, wherein the multiple security measures are selected from password entry, fingerprint reading, facial recognition, voice recognition, and combinations thereof. The method further comprises increasing a number of the security measures that are required for the user to gain access to the resource as a function of an amount of time passing since the user last accessed the resource, and granting the user access to the resource in response to the user satisfying each of the security measures required at any given time.

### BRIEF DESCRIPTION OF THE SEVERAL VIEWS OF THE DRAWINGS

FIG. 1 is a block diagram of a communication device that may implement embodiments of the present invention.

FIG. 2 is a diagram of an alternative compute node (or simply “computer”) that may implement embodiments of the present invention.

FIG. 3 is a diagram of a security preferences table storing three levels of passwords.

FIGS. 4A-C are diagrams of a graphical user interface providing a visual display of a password prompt and the number of characters in the password.

FIG. 5 is a flowchart of a method in accordance with one embodiment of the present invention.

### DETAILED DESCRIPTION

One embodiment of the present invention provides a method comprising a user storing a first password and a second password in memory of the electronic device, wherein the first password and the second password are used for gaining access to a resource of the electronic device, and wherein the second password has greater password strength than the first password. The method further comprises, during a first time period passing since the user last accessed the resource, the electronic device granting the user access to the resource in response to receiving the first password, and, during a second time period following the first time period, the electronic device granting the user access to the resource only in response to receiving the second password.

Unlike current security systems, a user will have a first password and a second password. If the system is a multi-user system, then each user will have a first password and a second password. As time passes since a particular user has accessed a resource, the system will initially require the user to submit the first password to gain access to the resource and will eventually require the user to submit the second (stronger) password to gain access to the resource. The resource may, for example, be a software application or a hardware device that is controlled by a software driver or other application. Non-limiting examples of the electronic device include a mobile communication device and a computer.

According to the foregoing embodiment of the invention, the second password has greater password strength than the first password. The term “password strength” refers to the average number of attempts that would be required for a third party without knowledge of the passwords to guess the password correctly. For example, the second password may have greater strength than the first password by including a greater number of characters than the first password. In such an instance, the method may display a prompt indicating the number of characters that are required in the password that is required at any given time. As another example, the second password may have greater strength than the first password by including at least one special character while the first password does not include any special characters. Optionally, the at least one special character may be selected from !, @, #, $, %, ̂, &, *, (,), _, +, and combinations thereof. These special characters are available on a standard QWERTY keyboard. In yet another example, the second password may have greater strength than the first password by including at least one upper case alphabetic character while the first password does not include any upper case alphabetic character. In general, password strength may be increased by increase the size of the character set, the length of the password, and the randomness of the character selection.

The method preferably includes displaying a prompt indicating the password strength that is required at any given time. Such a prompt may indicate the length of the password, the prompt may be a textual description of the required password strength or an image representing the required password strength, such as a background or an icon.

Optionally, the time periods associated with each of the first and second passwords may be stored in the security preferences of the electronic device. For example, a first password may be sufficient for a user to gain access to a resource during a first time period (beginning immediately upon lock out or log off) and a second password is necessary for the same user to gain access to the resource during a second time period following the first time period. Optionally, if the user did not manually lock of log off from the electronic device or resource, then the electronic device or resource may automatically lock or log off after a timeout period. In such an instance, the first time period preferably begins upon the electronic device or resource becoming automatically locked or logged off. The first and second time periods may be any user-configurable time period. The electronic device may track or otherwise determine the amount of time passing since the user last accessed (i.e., locked) the resource. Preferably, the amount of time will end upon successful entry of the required password.

The method determines which password is required as a function of time passing since the user last accessed the resource. The time at which the user last accessed the resource may be the time at which a user logged off the resource, the time at which the electronic device or software running on the device locked out the user, or the time at which the user provided a final input to the electronic device or software. The time period may begin at any other detectable event that indicates that the user may no longer be accessing the resource.

Another embodiment of the present invention provides a method comprising establishing multiple security measures for a user to gain access to a resource of an electronic device, wherein the multiple security measures are selected from password entry, fingerprint reading, facial recognition, voice recognition, and combinations thereof. The method further comprises increasing a number of the security measures that are required for the user to gain access to the resource as a function of an amount of time passing since the user last accessed the resource, and granting the user access to the resource in response to the user satisfying each of the security measures required at any given time. In a first option, the method may include displaying a prompt indicating the number of security measures that are required to unlock the electronic device at any given time. In a second option, the method may include displaying a prompt that identifies which one or more of the security measures are required for the user to unlock the electronic device at any given time.

One embodiment of the present invention provides a computer program product for controlling access to a resource of an electronic device, the computer program product comprising a computer readable storage medium having program instructions embodied therewith, wherein the program instructions are executable by a processor to cause the processor to perform a method. The method comprises storing a first password and a second password in memory of the electronic device, wherein the first password and the second password are used to allow a user to gain access to a resource of the electronic device, and wherein the second password has greater password strength than the first password. The method further comprises, during a first time period passing since the user last accessed the resource, granting the user access to the resource in response to receiving the first password, and, during a second time period following the first time period, granting the user access to the resource only in response to receiving the second password.

Another embodiment of the present invention provides a computer program product for controlling access to a resource of an electronic device, the computer program product comprising a computer readable storage medium having program instructions embodied therewith, wherein the program instructions are executable by a processor to cause the processor to perform a method. The method comprises establishing multiple security measures that must be satisfied before a user can gain access to a resource of an electronic device, wherein the multiple security measures are selected from password entry, fingerprint reading, facial recognition, voice recognition, and combinations thereof. The method further comprises increasing a number of the security measures that are required for the user to gain access to the resource as a function of an amount of time passing since the user last accessed the resource, and granting the user access to the resource in response to the user satisfying each of the security measures required at any given time.

The foregoing computer program products may further include computer readable program code for implementing or initiating any one or more aspects of the methods described herein. Accordingly, a separate description of the methods will not be duplicated in the context of a computer program product.

It should be understood that embodiments of the present invention provide increased security with time since use. As more time passed, it is more likely that the electronic device is in the hands of an unauthorized user. The increasing levels of security maintain ease of use while ensuring security.

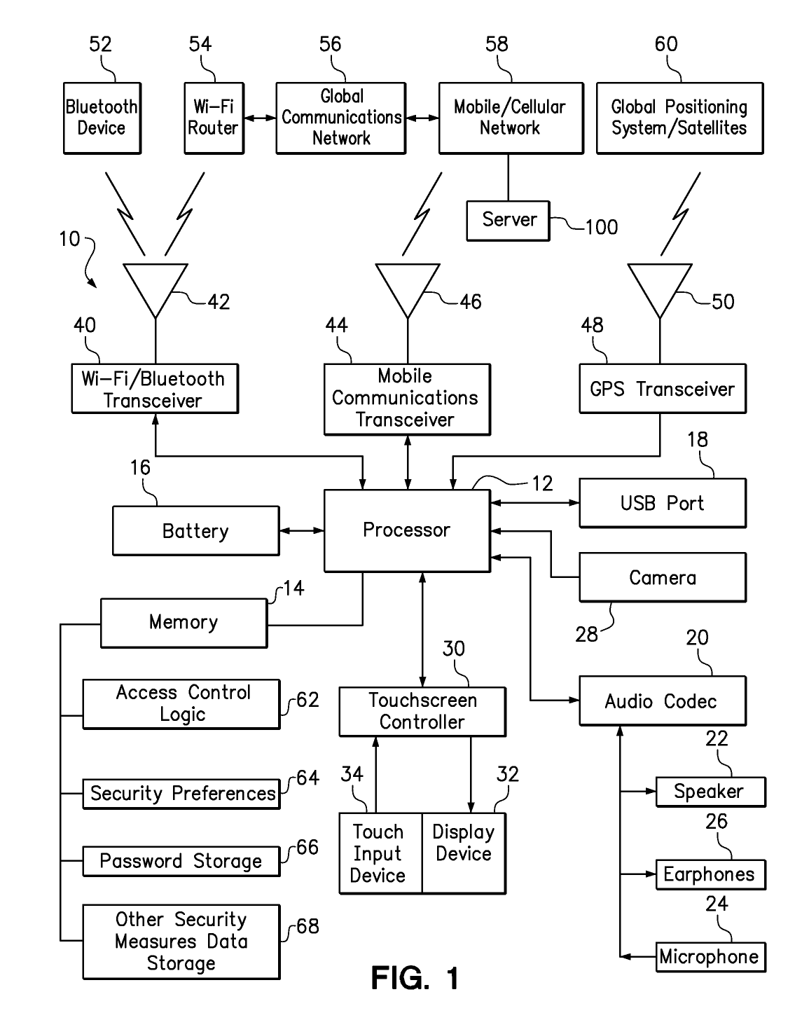

FIG. 1 is a block diagram of the components in one example of a communication device 10, such as a mobile communication device or smart phone, capable of implementing embodiments of the present invention. The mobile communication device 10 may include a processor 12, memory 14, a battery 16, a universal serial bus (USB) port 18, a camera 28, and an audio codec 20 coupled to a speaker 22, a microphone 24, and an earphone jack 26. The mobile communication device 10 may further include a touchscreen controller 30 which provides a graphical output to the display device 32 and an input from a touch input device 34. Collectively, the display device 32 and touch input device 34 may be referred to as a touchscreen.

The mobile communication device 10 may also include a Wi-Fi and/or Bluetooth transceiver 40 and corresponding antenna 42 allowing the device to communicate with a Bluetooth device 52 or a Wi-Fi router 54, a mobile communication transceiver 44 and corresponding antenna 46 allowing the device to communicate over a mobile/cellular network 58, and a global positioning system (GPS) transceiver 48 and corresponding antenna 50 allowing the device to obtain signals from a global positioning system or satellites 60. In a non-limiting example, the Wi-Fi router 54 and the mobile/cellular network 58 may be connected to a global communications network 56, such as the Internet. Furthermore, the mobile/cellular network 58 may include or access a server for the purpose of accessing various resources. As shown, the memory 14 stores an access control logic module 62, which may include voice/facial recognition modules, security preferences data 64, password storage 66, and other security measures data storage 68, which may include voice samples and facial images or data.

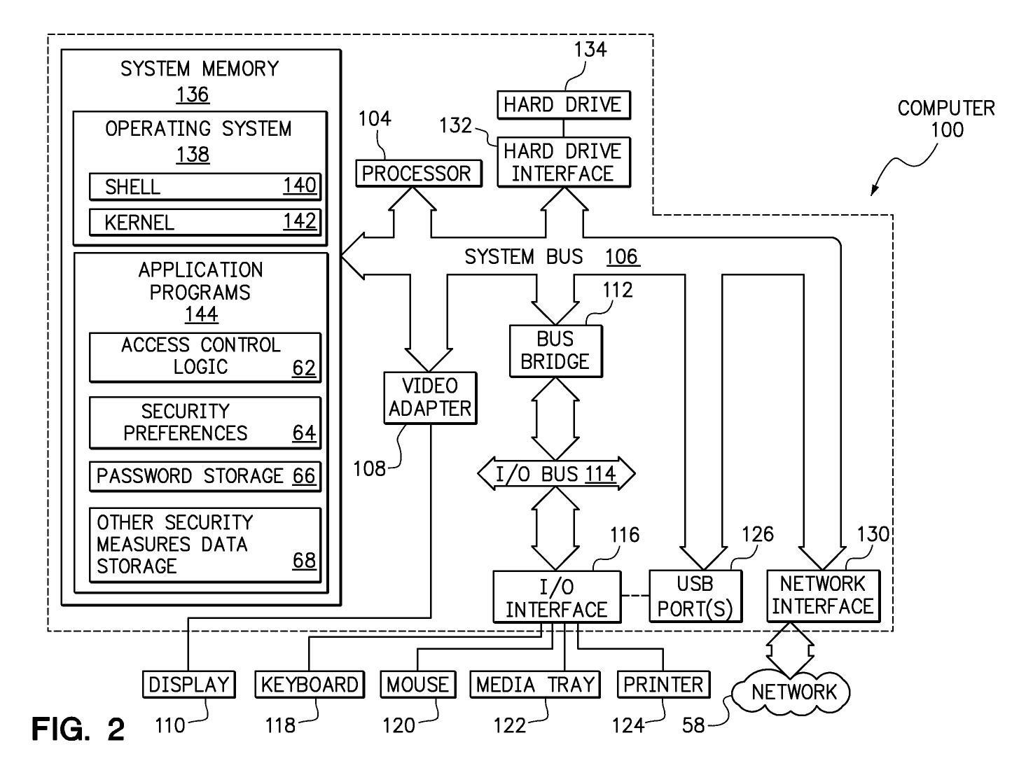

FIG. 2 is a diagram of an alternative compute node (or simply “computer”) that may implement embodiments of the present invention. The computer 100 includes a processor unit 104 that is coupled to a system bus 106. Processor unit 104 may utilize one or more processors, each of which has one or more processor cores. A video adapter 108, which drives/supports a display 110, is also coupled to the system bus 106. The system bus 106 is coupled via a bus bridge 112 to an input/output (I/O) bus 114. An I/O interface 116 is coupled to I/O bus 114. I/O interface 116 affords communication with various I/O devices, including a keyboard 118, a mouse 120, a media tray 122 (which may include storage devices such as CD-ROM drives, multi-media interfaces, etc.), a printer 124, and USB port(s) 126. While the format of the ports connected to I/O interface 116 may be any known to those skilled in the art of computer architecture, in one embodiment some or all of these ports are universal serial bus (USB) ports. As depicted, the computer 100 is able to communicate over a network 58 using a network interface 130. The network 58 may be an external network such as the cellular network or global communication network 56, and perhaps also an internal network such as an Ethernet or a virtual private network (VPN).

A hard drive interface 132 is also coupled to system bus 106. Hard drive interface 132 interfaces with a hard drive 134. In a preferred embodiment, the hard drive 134 populates a system memory 136, which is also coupled to system bus 106. System memory may be defined as a lowest level of volatile memory in computer 100. This volatile memory includes additional higher levels of volatile memory (not shown), including, but not limited to, cache memory, registers and buffers. Data that populates the system memory 136 includes operating system (OS) 138 and application programs 144.

The operating system 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 may be a text-based, line-oriented user interface, the present invention will equally well support other user interface modes, such as graphical, voice, gestural, etc.

As depicted, OS 138 also includes a kernel 142, which includes lower levels of functionality for the OS 138, including providing essential services required by other parts of OS 138 and application programs 144, including memory management, process and task management, disk management, and mouse and keyboard management. Application programs 144 in the system memory of computer 100 may include various programs and modules for implementing the methods described herein, such as the access control logic module 62, which may include voice/facial recognition modules, security preferences data 64, password storage 66, and other security measures data storage 68, which may include voice samples and facial images or data.

The hardware elements depicted in computer 100 are not intended to be exhaustive, but rather are representative components suitable to perform the processes of the present invention. For instance, computer 100 may include alternate memory storage devices such as magnetic cassettes, digital versatile disks (DVDs), Bernoulli cartridges, and the like. These and other variations are intended to be within the spirit and scope of the present invention.

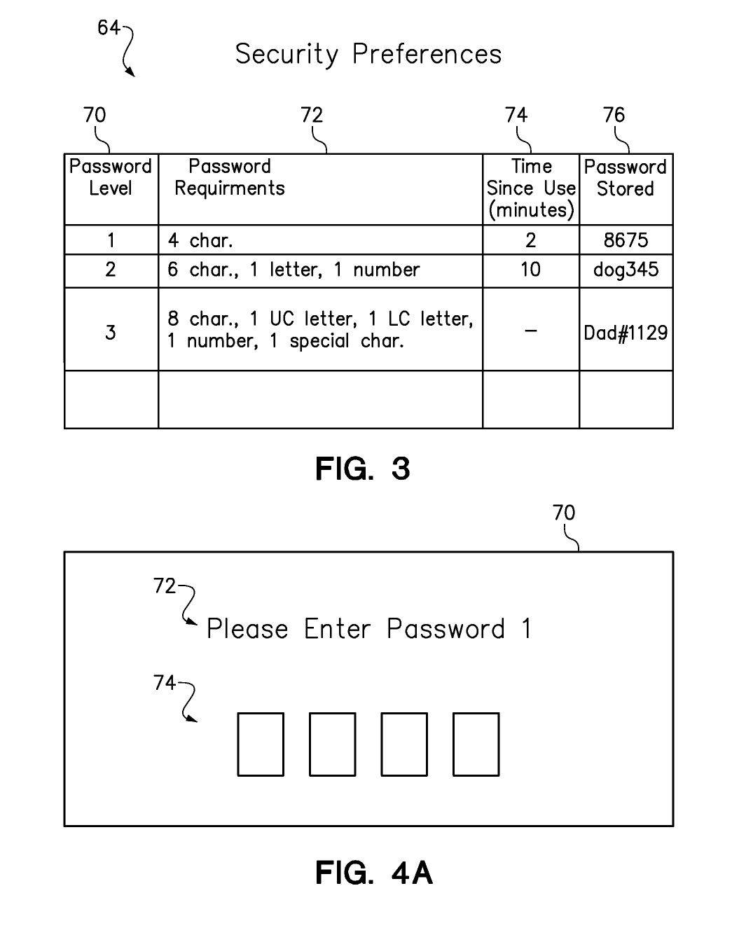

FIG. 3 is a diagram of a security preferences table 64 storing three levels of passwords. A first column 70 identifies the password level, a second column 72 identifies the password requirements associated with the particular password, a third column 74 identifies the when the time period associated with the particular password will end, and a fourth column 76 identifies the user's stored password. In the example of FIG. 3, a Level 1 password must have at least four characters and is sufficient for the user to gain access to a resource within 2 minutes of the user's most recent access to the resource. The user's Level 1 password has been stored as “8675”, which meets the password requirements for a first level password as specified in column 72. A Level 2 password must have at least six characters, including at least one letter (alphabetic character) and at least one number, and is sufficient for the user to gain access to a resource in the time period between 2 and 10 minutes following the user's most recent access to the resource. The user's Level 2 password has been stored as “dog345”, which meets the password requirements for a second level password as specified in column 72. This user has also set up a Level 3 password, which must have at least eight total characters, including at least one upper case letter, at least one lower case letter, at least one number, and at least one special character. The user has set up the Level 3 password to be sufficient for the user to gain access to the resource after expiration of the previous time period (10 minutes) since the user's most recent access to the resource. The user's Level 3 password has been stored as “Dad*1129”, which meets the password requirements for a second level password as specified in column 72.

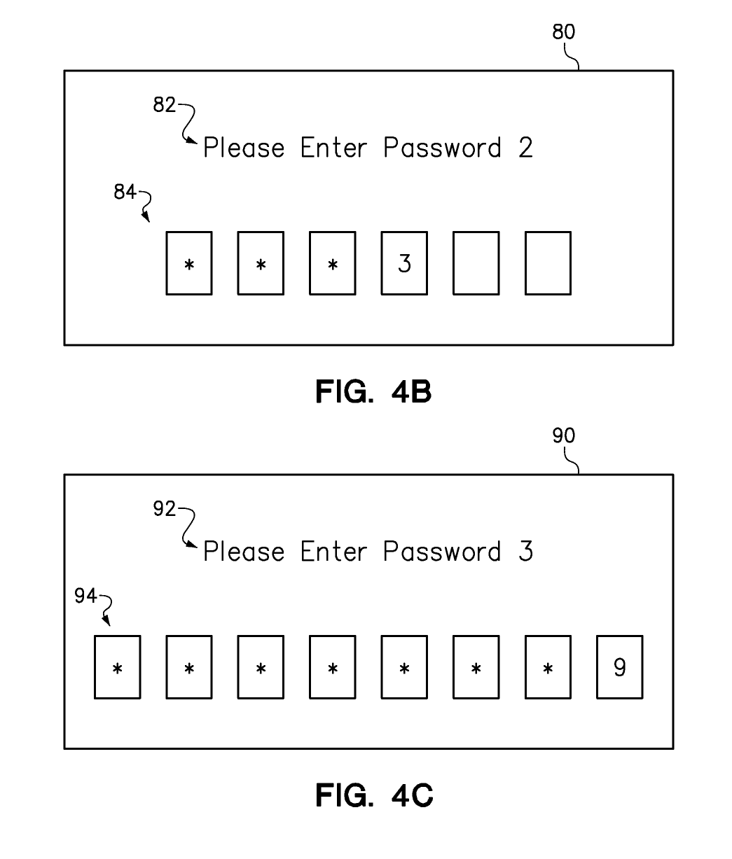

FIGS. 4A-C are diagrams of a graphical user interface providing a visual display of a password prompt and the number of characters in the password. FIG. 4A shows a graphical user interface 70 displaying a textual prompt 72 for the user to enter Password 1 and an indication 74 of the number of characters in the stored password for the current password level (Password 1). As shown the four boxes indicate that the user must enter a password having four characters. FIG. 4B shows a graphical user interface 80 displaying a textual prompt 82 for the user to enter Password 2 and an indication 74 of the number of characters in the stored password for the current password level (Password 2). The six boxes indicate that the user must enter a password having six characters. As shown, the user has entered the first four characters of the password, such that the first three characters have been masked with asterisks and only the fourth character is still shown. FIG. 4C shows a graphical user interface 90 displaying a textual prompt 92 for the user to enter Password 3 and an indication 94 of the number of characters in the stored password for the current password level (Password 3). The eight boxes indicate that the user must enter a password having eight characters. As shown, the user has entered all eight characters of the password, such that the first seven characters have been masked with asterisks and only the eighth character is still shown. If the user has entered the correct eight characters of the Password 3, then the user will be granted access to the requested resource.

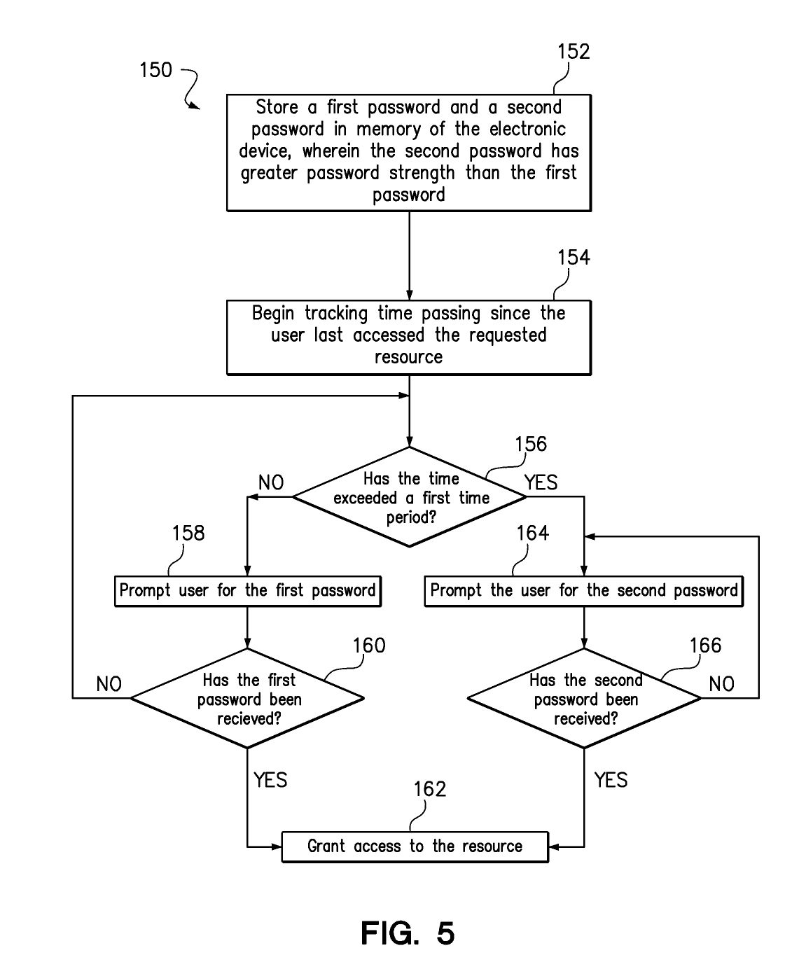

FIG. 5 is a flowchart of a method 150 of controlling access to a resource of an electronic device in accordance with one embodiment of the present invention. In step 152, a first password and a second password are stored in memory of the electronic device, wherein the second password has greater password strength than the first password. Prior to use of the passwords, the user will enter both of the first and second passwords into the electronic device for later authenticating that the user should be granted access to a given resource. Both passwords are checked to assure that they meet the password requirements for the first and second passwords, respectively. In step 154, the method begins tracking the amount of time passing since the user last accessed the requested resource. This may begin when the electronic device has been locked or the resource has been logged out.

Step 156 determines whether the time has exceeded a first time period. If the time has not exceeded the first time period, then step 158 will prompt the user for the first password. If step 160 determines that the first password has been received, then step 162 grants the user access to the resource. However, if step 160 determines that the first password has not yet been received, then the method returns to step 156 to determine whether the time has exceeded the first time period. If not, then steps 158 and 160 are repeated until either the first password is received or the first time period expires.

When step 156 determines that the time has exceeded the first time period, then step 164 prompts the user for the second password. If the second password has been received in step 166, then step 162 grants the user access to the resource. However, if step 166 determines that the second password has not been received, then the method returns to step 164 such that no access is granted until the second password has in fact been received.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A computer program product for controlling access to a resource of an electronic device, the computer program product comprising a non-transitory computer readable storage medium having program instructions embodied therewith, the program instructions executable by a processor to cause the processor to perform a method comprising:
storing a first password and a second password in memory of the electronic device, wherein the first password and the second password are used to allow a user to gain access to a resource of the electronic device, wherein the second password has greater password strength than the first password;
during a first time period passing since the user last accessed the resource, granting the user access to the resource in response to receiving the first password; and
during a second time period following the first time period, granting the user access to the resource only in response to receiving the second password.

2. The computer program product of claim 1, wherein the electronic device is a mobile communication device.

3. The computer program product of claim 1, wherein the electronic device is a computer.

4. The computer program product of claim 1, wherein the second password includes a greater number of characters than the first password.

5. The computer program product of claim 4, the method further comprising:
displaying an indication of the number of characters that are required in the password that is required at any given time.

6. The computer program product of claim 1, wherein the second password includes at least one special character and the first password does not include any special characters.

7. The computer program product of claim 6, wherein the at least one special character is selected from !, @, #, $, %, ̂, &, *, (,), _, +, and combinations thereof.

8. The computer program product of claim 1, wherein the second password includes at least one upper case alphabetic character and the first password does not include any upper case alphabetic character.

9. The computer program product of claim 1, wherein password strength is measured as the average number of attempts that would be required to guess the password correctly.

10. The computer program product of claim 1, the method further comprising:
displaying a prompt indicating the password strength that is required at any given time.

11. The computer program product of claim 10, wherein the prompt is an image selected from a background and an icon.

12. The computer program product of claim 1, wherein the first time period begins in response to the electronic device becoming locked.

13. The computer program product of claim 1, wherein the first time period begins in response to logging out of the resource.

14. A computer program product for controlling access to a resource of an electronic device, the computer program product comprising a non-transitory computer readable storage medium having program instructions embodied therewith, the program instructions executable by a processor to cause the processor to perform a method comprising:
establishing multiple security measures that must be satisfied before a user can gain access to a resource of an electronic device, wherein the multiple security measures are selected from password entry, fingerprint reading, facial recognition, voice recognition, and combinations thereof;
increasing a number of the security measures that are required for the user to gain access to the resource as a function of an amount of time passing since the user last accessed the resource; and
granting the user access to the resource in response to the user satisfying each of the security measures required at any given time.

15. The computer program product of claim 14, the method further comprising:
displaying a prompt indicating the number of security measures that are required to unlock the electronic device at any given time.

16. The computer program product of claim 14, the method further comprising:
displaying a prompt identifying more than one of the security measures required to unlock the electronic device at any given time.

17. A computer program product for controlling access to a resource of an electronic device, the computer program product comprising a non-transitory computer readable storage medium having program instructions embodied therewith, the program instructions executable by a processor to cause the processor to perform a method comprising:
storing a first password and a second password in memory of the electronic device, wherein the first password and the second password are used to allow a user to gain access to a resource of the electronic device, wherein the second password has greater password strength than the first password, the second password includes a greater number of characters than the first password, the second password includes at least one special character and the first password does not include any special characters, and the second password includes at least one upper case alphabetic character and the first password does not include any upper case alphabetic character;
during a first time period passing since the user last accessed the resource, granting the user access to the resource in response to receiving the first password; and
during a second time period following the first time period, granting the user access to the resource only in response to receiving the second password.

18. The computer program product of claim 17, wherein the at least one special character is selected from !, @, #, $, %, ̂, &, *, (,), _, +, and combinations thereof.

19. The computer program product of claim 17, the method further comprising:
displaying a prompt indicating the password strength that is required at any given time.

20. The computer program product of claim 17, the method further comprising:
displaying an indication of the number of characters that are required in the password that is required at any given time.
